(19) United States
(12) Patent Application Publication
(10) Pub. No.: US 2006/0009064 A1
(43) Pub. Date: Jan. 12, 2006

(54) Board cover

(75) Inventor: Brian Leslie Cregan, Berrara, New South Wales (AU)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Ocean & Earth Australia Pty Ltd

(21) Appl. No.: 11/155,920

(22) Filed: Jun. 15, 2005

(30) Foreign Application Priority Data
Jul. 7, 2004 (AU) 2004903703

(51) Int. Cl. H01R 4/24

(52) U.S. Cl. 439/395

(57) ABSTRACT

A board cover for holding boards such as for example surfboards, kiteboards, wakeboards, snowboards, bodyboards, mountain boards, land boards, skim boards, the board cover including: a bag for receiving a board; a hanger assembly for hanging the bag in a display or storage position; the hanger assembly operatively connected to the bag, the hanger assembly further including a catch and a mounting device operatively connected thereto for mounting the catch.

### FIELD OF THE INVENTION

The present invention relates generally to board covers such as those used to cover and thereby protect surfboards, kiteboards, wakeboards, snowboards, bodyboards and the like.

### BACKGROUND TO THE INVENTION

Board covers are generally provided to cover and protect surfboards and like boards from damage—which may occur while the board is being transported between its storage location and its use location. Transportation damage occurs because boards are moved on car roofs, and within aeroplane cargo holds and the like. Damage may also occur while the board is in storage, or during transportation in cargo holds, as the board—in its board cover—is stored flat, which generally invites users to store other heavy and possibly sharp items on top of the board. Items may be bashed against the board and cover while trying to get heavy items over the board and cover, which may damage the board and reduce performance thereof.

Known designs of board covers do provide some protection from these incidents, however, there are limitations to their usefulness as they must be a balance between being portable, strong, thick heavy and durable. This is in order to ameliorate damage from accidents during storage and transport, as well as being light enough to transport.

Furthermore, in retail environments, board covers are often displayed in piles so that it is difficult to see each one's features and benefits.

The present invention seeks to ameliorate one or more of the abovementioned disadvantages.

### SUMMARY OF THE INVENTION

According to one aspect of the present invention there is provided a board cover for holding boards such as for example surfboards, kiteboards, wakeboards, snowboards, bodyboards, mountain boards, land boards, skim boards, the board cover including:
a bag for receiving a board;
a hanger assembly for hanging the bag in a display or storage position;
the hanger assembly operatively connected to the bag, the hanger assembly further including a catch and a mounting device operatively connected thereto for mounting the catch.

The board cover preferably includes a pair of opposed side walls made of protective, durable material, each wall generally being of material such as for example woven tear-resistent fabric material skins filled with foam padding of various thickness.

The board cover preferably includes an opening to access the space between opposed walls, having a closure, the closure in one form being a zipper. Preferably the opening extends around a peripheral end portion of the board cover, and, in preferred embodiments, the opening extends to portions of the board cover's side periphery also.

The mounting device may provide any suitable type of mounting, and the mounting device may be mounted at any suitable location on or in the board cover. In preferred embodiments, however, the mounting device provides detachable mounting of the catch. Preferably the mounting device is mounted on an inside face of the board cover, adjacent the opening or outer end, or tail end of the board cover.

The mounting device may be openable by any suitable method to provide the detachable mounting of the catch. In one form, the mounting device is openable at an opening end to release the catch. The catch, in an installed position, is mounted to the mounting device at a return end of the mounting device. The return end of the mounting device is adjacent the outer end of the board cover. The opening end is disposed at the end distal the return end of the mounting device.

In preferred embodiments the mounting device includes a pair of opposed jaws, pivotable at the return end. Preferably each jaw is a flexible ribbon, and in one embodiment each jaw is provided with complementary hook-and-loop fasteners on opposing faces, the opposing faces abutting when in an engaged position. Preferably one flexible jaw is sewn onto the inside face of the board cover, from an opening end to a return or pivot end.

Preferably the catch is in the form of a hook which is adapted to engage with a corresponding projection, rack, finger, eye or other fastening, itself projecting from a wall.

Preferably the catch includes an aperture through which the mounting device may pass. In one form the aperture is a slot passing from one side wall to another side wall of the catch.

Preferably the hook is a generally flat device, so that it may be stored within the board cover without adding significantly to the volume or bulk of the board cover.

Preferably the slot is disposed adjacent one end of the catch so that the catch may pivot generally about one end, whereby the catch may fold inside the dimensions of the board cover when desired.

A pocket may be provided so that the catch, when detached from the mounting device, may be stored within the board cover while remaining within a generally accessible location.

The pocket may include an opening, the opening in one form having a closure, and in preferred forms the closure has retaining means in the form of hook-and-loop fasteners to reduce volume and bulk of the board cover.

### DESCRIPTION OF THE PREFERRED EMBODIMENTS

In order to enable a clearer understanding, the invention will hereinafter be described with reference to drawings and description of preferred embodiments. In the drawings:

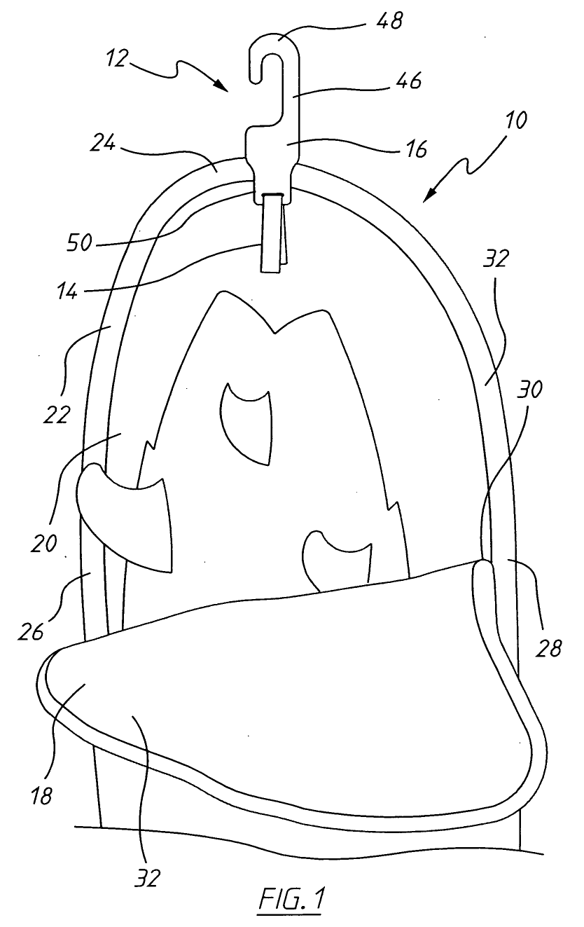

FIG. 1 is an isometric view of a board cover in accordance with a preferred embodiment of the present invention, the board cover having a top wall peeled back to reveal an interior of the board cover, upon which is mounted a hanger assembly;

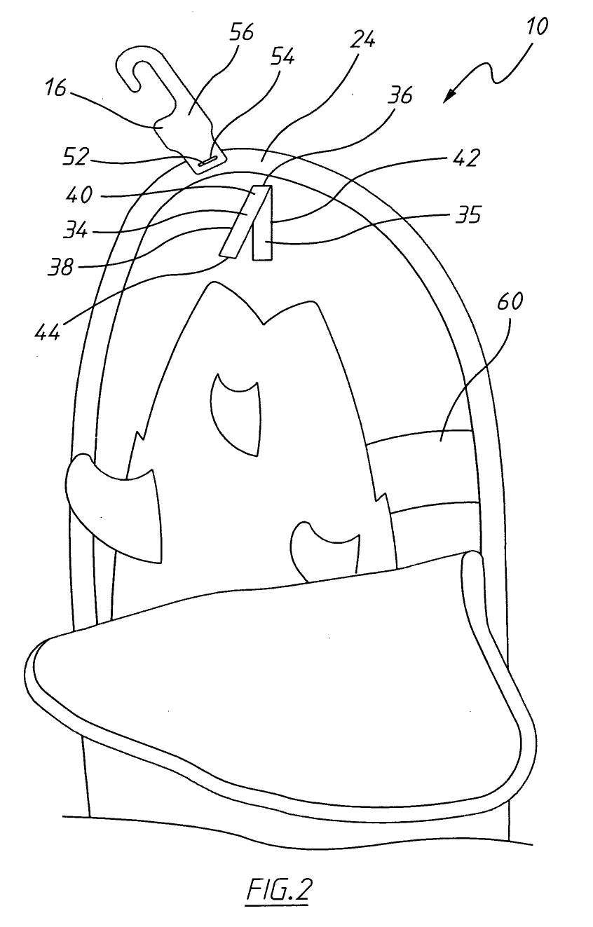

FIG. 2 is an isometric view very similar to that shown in FIG. 1, however, the hanger assembly is displaying in exploded view its major component parts—a mounting device and a catch;

Referring to the Figures there is shown a board cover generally indicated at 10, the board cover 10 including a hanger assembly 12 which includes a mounting assembly 14 and a catch 16.

The board cover 10 includes opposed top and bottom walls 18 and 20 respectively, the top 18 and bottom 20 walls being joined by a peripheral edge portion 22. Around the majority of the peripheral edge portion 22, the walls are merely fixed together. However, around at least the entirety of a rear end 24 and a portion of adjacent sides 26 and 28, the peripheral edge portion 22 is openable and closable by a closure 30 in the form of a zipper 32.

The top 18 and bottom 20 walls are formed from layers of tear-resistant fabric 32, each wall generally consisting of two layers of material 32, between which are placed some load-spreading foam padding of various thickness (not shown).

The mounting assembly 12 includes a pair of opposed jaws—upper 34 and lower 35—which are connected to one another at a return end 36, and the jaws 34 and 35 also pivot relative to one another about the return end 36. Each jaw 34, 35 is constructed from a flexible material 38. Upper jaw 34 is in the form of a ribbon of hook material 40 and lower jaw 35 is in the form of a ribbon of loop material 42. Each jaw 34, 35 may be separated from each other by tearing apart, which is generally performed the most easily by tearing upper jaw 34 upwards, commencing from an opening end 44, distal the return end 36.

The catch 16 is in the form of a hook 46, the hook 46 having a U-shaped hook end 48, and a mounting end 50. The mounting end 50 includes an aperture 52 in the form of a through slot 54, which passes from one side wall 56 of the catch to the other side wall (not shown). The slot 54 is disposed at the mounting end 50 so that the catch 16 may pivot about the mounting end 50. The catch 16 is generally a flat device so that, when stored away inside the board cover 10, it does not add significantly to the volume of the board cover 10.

The return end 36 of the mounting device 14 is disposed adjacent a rear end 24 of the board cover 10 so that the catch 16 may extend to a use position wherein the catch 16 is substantially outside the peripheral edge portion 22 of the board cover 10. This allows the U-shape hook end 48 to more easily engage with a corresponding finger which may be mounted on a wall (not shown). The mounting end 50 of the catch 16 may also pivot about the return end 36 to allow the catch 16 to pivot to a storage position inside the confines or peripheral edge 22 of the board cover 10.

A pocket 60 may also be provided inside the board cover 10 to provide a storage location for the catch 16 which may be detached from the mounting device 14. The pocket 60 includes a closure across the opening, the closure in the form of hook-and-loop fasteners, to reduce the volume occupied by the board cover, and to improve access to the pocket 60.

To assemble, the mounting device 14 is placed in an open position wherein the opposed jaws 34 and 35 are pivoted upwards about the return end 36. The opening end 44 of the upper jaw 34 is threaded through the slot 54 of the catch 16. The slot 54 is moved up jaw 34 until the mounting end 50 of the catch 16 reaches the return end 36. The mounting device 14 is then placed in a closed position by pivoting the jaws 34 and 35 back to a closed position wherein they abut one another, lying substantially parallel with one another their hooks and loops engaging.

The board cover 10 may then be placed on a finger projecting outwardly from a wall (not shown). The board cover 10 is now in a generally vertical, hanging position, which substantially ameliorates any temptation to store other items on top of the board cover 10. If items are placed against the board cover 10, the forces they exert against any board which may be inside the cover 10 are reduced to a great extent.

In order to pack the hanger assembly 12 away, it is a simple matter of taking the board cover 10 off the wall and pivoting the catch 16 about the mounting end 50, mounted at the return end 36 of the mounting device 14. The catch 16 is then inside the periphery 22 of the board cover 10. The zipper may then be closed and the board cover placed on, say, a car roof for transportation to a use location (for example, in the case of a surfboard: the surf).

To disassemble, the board cover 10 is removed from the projecting finger (not shown) and laid down. The mounting assembly 14 is opened as described above, the slot 54 is taken to the end 44 and removed, and the catch 16 placed in the pocket 60 or generally thrown somewhere in the interior of the board cover 10 so that the catch 16 is not lost.

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

We claim:

1. A board cover for holding boards such as for example surfboards, kiteboards, wakeboards, snowboards, bodyboards, mountain boards, land boards, skim boards, the board cover including:
a bag for receiving a board;
a hanger assembly for hanging the bag in a display or storage position;
the hanger assembly operatively connected to the bag, the hanger assembly further including a catch and a mounting device operatively connected thereto for mounting the catch.

2. A board cover in accordance with claim 1 wherein the bag includes a pair of opposed side walls made of protective, durable material.

3. A board cover in accordance with claim 2 wherein each wall is constructed of woven tear-resistent fabric filled with foam padding of selected thickness

4. A board cover in accordance with claim 1 wherein the bag includes an opening to access a void between opposed walls, the opening having a closure.

5. A board cover in accordance with claim 4 wherein the closure is in the form of a zipper.

6. A board cover in accordance with claim 4 wherein the opening extends around a peripheral end portion of the board cover.

7. A board cover in accordance with claim 6 wherein the opening extends to portions of a side periphery of the board cover.

8. A board cover in accordance with claim 1 wherein the mounting device is mounted on inner or outer walls of the bag, adjacent the opening or outer end, or tail end of the bag.

9. A board cover in accordance with claim 1 wherein the mounting device provides detachable mounting of the catch.

10. A board cover in accordance with claim 1 wherein the mounting device is mounted on an inside face of the bag.

11. A board cover in accordance with claim 1 wherein the mounting device is adapted to open at an opening end of the mounting device to release the catch.

12. A board cover in accordance with claim 1 wherein the catch, in an installed position, is mounted to the mounting device at a return end of the mounting device.

13. A board cover in accordance with claim 12 wherein the return end of the mounting device is adjacent the peripheral end portion of the board cover.

14. A board cover in accordance with claim 11 wherein the opening end of the mounting device is disposed distal the return end of the mounting device.

15. A board cover in accordance with claim 1 wherein the mounting device includes a pair of opposed jaws, adapted to pivot at the return end.

16. A board cover in accordance with claim 15 wherein each jaw is a flexible ribbon, and each respective jaw is provided with complementary hook-and-loop fasteners on opposing faces, the opposing faces abutting and engaging when in an engaged position.

17. A board cover in accordance with claim 11 wherein one flexible jaw is sewn onto the inside face of the board cover.

18. A board cover in accordance with claim 1 wherein the catch is in the form of a hook.

19. A board cover in accordance with claim 1 wherein the catch includes an aperture through which the mounting device may pass.

20. A board cover in accordance with claim 19 wherein the aperture is a through slot.

21. A board cover in accordance with claim 18 wherein the hook is a generally flat device, so that it may be stored within the board cover without adding significantly to the volume or bulk of the board cover.

22. A board cover in accordance with claim 20 wherein the slot is disposed adjacent one end of the catch so that the catch may pivot generally about one end, whereby the catch may fold inside the dimensions of the board cover when desired.

23. A board cover in accordance with claim 1 wherein a pocket is provided so that the catch, when detached from the mounting device, may be stored within the board cover while remaining within a generally accessible location.

24. A board cover in accordance with claim 23 wherein the pocket includes an opening, the opening in one form having a closure; the closure having retaining means in the form of hook-and-loop fasteners for holding the pocket closed and to reduce volume and bulk of the board cover.

25. A board cover substantially as hereinbefore described with reference to the attached drawings.
